(19) United States
(12) Patent Application Publication
(10) Pub. No.: US 2006/0228457 A1
(43) Pub. Date: Oct. 12, 2006

(54) Frozen carbonated beverage, concentrate and method

(76) Inventors: Rachel L. Jordan, Palatine, IL (US); Christine M. Benza, Cary, IL (US); Jessica L. Franklin, St. Petersburg, FL (US)

Correspondence Address: PEPSICO, INC.;c/o GOODWIN PROCTER LLP, EXCHANGE PLACE, BOSTON, MA, 02109, US

(21) Appl. No.: 11/100,217

(22) Filed: Apr. 6, 2005

(51) Int. Cl. A23G 9/00

(52) U.S. Cl. 426/565

(57) ABSTRACT

The present invention is a frozen carbonated beverage, a method of making a frozen carbonated beverage and a frozen carbonated beverage concentrate. The frozen carbonated beverage and frozen carbonated beverage concentrate contain fruit juice. The frozen carbonated beverage and concentrate, respectively, may be a reduced calorie frozen carbonated beverage and concentrate.

### FIELD OF THE INVENTION

The present invention relates to frozen carbonated beverages, methods of making frozen carbonated beverages and concentrates for making frozen carbonated beverages. The present invention also relates to frozen carbonated beverages that are of reduced calorie content.

### BACKGROUND OF THE INVENTION

Frozen carbonated beverages (“FCB”s) are known in the art and have been produced for years. Typically, FCBs are produced via devices that freeze a mixture of ingredients including syrup, water and carbon dioxide in a mixing chamber. Those devices are well-known in the art and thus a detailed description of such devices is not provided. Such devices work by causing the mixture to freeze on the inner surface of the mixing chamber of the device which typically is surrounded by a coil through which a refrigerant passes. Typically, a mixing blade disposed inside the chamber scrapes the mixture off the inside wall of the chamber. Once the carbonated beverage is in the desired frozen state, the product is dispensed from the chamber such as through a product valve and into a container for consumption by a consumer.

### SUMMARY OF THE INVENTION

In accordance with the present invention, a frozen carbonated beverage (“FCB”) is provided that comprises from about 1% to about 100% and more typically about 1% to about 50% by volume juice, carbon dioxide and water. FCB concentrates in accordance with the invention are also provided and may comprise from about 2% to about 200% by weight juice. For purposes of this disclosure, % by weight juice means the percentage of juice soluble solids present divided by the percentage of juice soluble solids, as defined in 21 CFR 101-102, that corresponds to the standard of identity for that fruit or vegetable as 100% juice. The frozen carbonated beverage and concentrate in accordance with the invention may incorporate juice of any desired type and may be vegetable or fruit juice that can be fresh or from concentrate and mixtures thereof. Typical fruit juices for use in accordance with the invention include, as examples and not as limitations of the invention, apple, pear, orange, grape, raspberry, strawberry, cranberry, pineapple, grapefruit, mango, guava, banana, tomato, lemon, lime, cherry, peach, kiwi, pomegranate and mixtures thereof. Typically, vegetable juices include, as examples and not as limitations of the invention, carrot, celery, pepper, cucumber, spinach, beets, lettuce, watercress and mixtures thereof. As used herein, the term “juice” means liquid obtained from a fruit or vegetable as indicated by the particular context.

A significant advantage of the present invention is that the FCB concentrate composition can be used to produce a FCB in conventional frozen carbonated beverage machines, such as those marketed by IMI Cornelius of Osseo, Minn. and Lancer FBD of San Antonio, Tex. The FCB compositions in accordance with the invention can behave like a standard or conventional sugar-based frozen carbonated syrup that is used to make an FCB in frozen carbonated beverage machines. Those machines are well-known in the art.

In accordance with another aspect of the present invention, the frozen carbonated beverage typically comprises from about 2% to about 25% by volume juice, and more preferably, from about 2% to about 10% by volume juice and most preferably in the range of about 4% to about 6% or more. The concentrate can have proportional ranges to achieve the desired final FCB product concentrations.

In accordance with another aspect of the present invention, the frozen carbonated beverage further comprises a sweetener selected from the group consisting of nutritive and non-nutritive sweeteners and mixtures thereof.

In accordance with still another aspect of the present invention, a concentrate for making a frozen carbonated beverage is provided that comprises from about 2% to about 200% and more typically from about 6% to about 80% by weight juice, a foaming agent and water. In accordance with another embodiment of this aspect of the invention, the concentrate comprises from about 2% to about 25% by weight juice. Concentrated fruit juice may be utilized in the concentrate and the concentrate may thus comprise from about 0.16% to about 99% or more and more typically from about 0.4% to about 25% by weight of a juice concentrate. Typically, the juice concentrate is from about 2:1 to about 7:1 on a juice concentrate:juice basis. An acidifier may also be included in the FCB concentrate and the resulting FCB of the present invention. In addition, flavors, vitamins, minerals, nutraceuticals, protein, fiber, essential nutrients, amino acids, phytochemicals and suitable preservatives may also be incorporated into the FCB concentrates and beverages of the present invention.

In accordance with another aspect of the present invention, a method of making a frozen carbonated beverage is provided that comprises combining fruit juice, water and carbon dioxide at reduced temperature.

In accordance with another aspect of the present invention, the frozen carbonated beverage may be a reduced calorie frozen carbonated beverage comprising from about 1-50% and more typically about 1-25% juice by volume, a reduced calorie or non-caloric sweetener, a freezing point depressant, water and carbon dioxide. In another embodiment in accordance with this aspect of the invention, the frozen carbonated beverage comprises from about 2% to about 10% juice by volume. In accordance with another aspect of this embodiment of the invention, the freezing point depressant is any non-nutritive or significantly non-nutritive suitable freezing point depressant for a frozen carbonated beverage and may be selected from the group consisting of tagatose, erythritol, isomalt, maltitol, lacitol and fructo-oligosaccharide sweetener and mixtures thereof, for example.

In accordance with another aspect of the present invention, a method of making a reduced calorie frozen carbonated beverage is provided. The method comprises combining from about 2% to about 100% and more typically about 2% to about 50% juice by volume, water, a reduced calorie or non-caloric sweetener, a freezing point depressant and carbon dioxide at reduced temperature. Optionally, a foaming agent may also be included as well as other ingredients as previously mentioned.

In accordance with still another aspect of the present invention, a reduced calorie frozen carbonated beverage concentrate is provided. The frozen carbonated beverage concentrate in accordance with this aspect of the invention comprises juice, typically fruit juice, water, a reduced calorie or non-caloric sweetener and optionally a non-nutritive sugar and an adjuvant freezing point depressant. In accordance with another embodiment of this aspect of the invention, the reduced calorie frozen carbonated concentrate comprises from about 2% to 100% and more typically about 2% to about 50% by weight juice. In accordance with still another aspect of this embodiment of the invention, the juice is present in concentrate form and may typically comprise from about 4% to about 25% by weight of the concentrate composition.

### DETAILED DESCRIPTION OF THE INVENTION

In accordance with the present invention, a frozen carbonated beverage is provided that comprises carbon dioxide, water and from about 1% to about 50% by volume juice. The frozen carbonated beverage in accordance with the invention may incorporate juice of any desired type and may be vegetable or fruit juice that may be fresh or from concentrate and mixtures thereof. Any juice known in the art can be used in the composition and methods of the invention as long as it does not deleteriously affect the invention or prevent formation of a frozen carbonated beverage. Typical fruit juices for use in accordance with the invention include, as examples and not limitations of the present invention, apple, pear, orange, grape, raspberry, strawberry, cranberry, pineapple, grapefruit, mango, guava, banana, tomato, lemon, lime, cherry, peach, kiwi, pomegranate and mixtures thereof. Typically, vegetable juices include, as examples and not as limitations of the invention, carrot, celery, pepper, cucumber, spinach, beets, lettuce, watercress and mixtures thereof.

Advantageously, the frozen carbonated beverage concentrate can be conveniently used in a standard, more conventional frozen carbonated beverage device that is typically used to make frozen carbonated beverages from sugar-based frozen carbonated beverage syrup.

In accordance with another aspect of the present invention, the frozen carbonated concentrate and resulting FCB of the present invention may include a sweetener. Suitable sweeteners can be selected from the group consisting of nutritive and non-nutritive sweeteners and mixtures thereof. More specifically, suitable sweeteners for use in accordance with the invention include high fructose corn syrup, sugar, other common sugars and/or any suitable non-nutritive sweetener including, as non-limiting examples, sucralose, ASK, aspartame and monatin.

Depending on the amount of common sugars present in the FCB concentrate and FCB in accordance with the present invention, a freezing point depressant may also be utilized, such as, for example, a sugar macro nutrient substitute (“MNS”). Suitable MNSs include, as non-limiting examples, erythritol, maltitol, xylitol, sorbitol and mixtures thereof. Salts and acids of MNSs may also be utilized in accordance with the invention. Preferably, a sufficient amount of a freezing point depressant should be used so that the FCB concentrate mimics the performance of a conventional sugar-based FCB composition when frozen in a conventional FCB machine.

The FCB concentrate may also include a suitable acidifier. Suitable acidifiers include, for example, citric acid, phosphoric acid, malic acid, ascorbic acid and mixtures thereof. A suitable amount of acidifier typically will be used to achieve a pH in the range of about 2 to about 3, preferably about 2.8 to about 3 and up to about a maximum of 3.5.

In accordance with another aspect of the present invention, the frozen carbonated beverage concentrate and the resulting frozen carbonated beverage further includes a foaming agent. The foaming agent may comprise any suitable food grade foaming agent or combination of agents known in the art by facilitating ice crystal formation achieving consistent carbon dioxide overrun. “Overrun” is the volume of carbon dioxide present in the frozen carbonated beverage in excess of the liquid volume. Preferably, the overrun is in the range of from about 50% to about 120%, more typically from about 80% to about 120% with 100% being a typical target overrun.

Suitable foaming agents are well known in the art and include, for example, quillaja, liquid Yucca, Yucca foam, any other suitable foaming agent or agents and mixtures thereof. Yucca and quillaja extract foaming agents are commercially available from Desert King International of San Diego, Calif. Typically, the amount of the foaming agent would be on the order of from about 0.10% to about 0.7% by weight of the total FCB concentrate composition, and other suitable ranges may be from about 0.05% to about 1% or more.

The frozen carbonated beverage concentrate and resulting frozen carbonated beverage may also include suitable preservatives. Any suitable preservative can be used in accordance with the invention. Typical preservatives include, for example, sodium benzoate, potassium sorbate, sodium hexametaphosphate, EDTA and mixtures thereof. Typical concentrations of sodium benzoate and potassium sorbate are, for example, in the range of from about 0.03% to about 0.15% by weight of the total FCB concentrate composition. Preferably, sodium benzoate and potassium sorbate are used in combination in amounts of about 0.1% by weight of the total FCB concentrate composition.

In accordance with another aspect of the invention, vitamins may be present in the frozen carbonated beverage concentrate and resulting frozen carbonated beverage of the invention. Any suitable vitamin and mineral and concentrations thereof can be added to the frozen carbonated beverage concentrate in accordance with the invention provided that the added vitamins and minerals do not excessively deleteriously affect formation of a frozen carbonated beverage having a smooth, slushy texture using a conventional frozen carbonated beverage device. Preferably, the amount of vitamins added are 10% of the recommended daily requirement for the particular vitamins added. In accordance with one embodiment, a B-vitamin premix is utilized containing 50% by weight niacinimide, 27.47% D-calcium pantothenate and 22.53% maltodextrin. Other vitamins that may be added include Vitamin C (ascorbic acid), Vitamin B6, thiamin, riboflavin, Vitamin A, Vitamin D, Vitamin E and folic acid. Examples of minerals that may be added include calcium, potassium, zinc and magnesium.

Preferably, the frozen carbonated beverage composition will be formulated such that at least 5% by volume juice and at least 10% of the daily requirements of niacin and pantothenic acid are provided in a standard size serving of the frozen carbonated beverage in its carbonated, frozen state and the carbon dioxide overrun is in the range of from about 80% to 120%.

The following are examples of a frozen carbonated beverage concentrate composition in accordance with the present invention:

| Component | Parts by Weight |
|---|---|
| Example I | |
| Filtered Water | 17.3 |
| Sodium Benzoate | 0.1 |
| Potassium Sorbate | 0.1 |
| High Fructose Corn Syrup | 65.6 |
| Citric Acid | 1.4 |
| B-Vitamin Premix (*) | 0.4 |
| Pear Juice Concentrate (70.3brix) | 11.6 |
| Purple Grape Juice Concentrate (68.7brix) | 1.1 |
| Flavors | 2.5 |
| Foaming Agent (80% Quillaia Extract and | 0.3 |
| 20% Yucca Extract) | |
| Example II | |
| High Fructose Corn Syrup | 62.4 |
| Filtered Water | 19.7 |
| Orange Concentrate | 11.7 |
| Orange Strawberry Banana Flavor | 4.1 |
| Citric Acid | 1.3 |
| PepsiCo Foaming Component | 0.3 |
| Sunflower Yellow Liquid Color | 0.1 |
| Sodium Benzoate | 0.1 |
| Potassium Sorbate | 0.1 |
| Yellow 5 Liquid Color | 0.6 |
| B-Vitamin Premix (*) | .04 |

(*) Contains 50% by weight Niacinimide, 27.47% by weight D-calcium pantothenate and 22.53% maltodextrin.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A frozen carbonated beverage comprising:
from about 1% to about 50% by volume fruit juice;
carbon dioxide; and
water.

2. The frozen carbonated beverage of claim 1 wherein said fruit juice is selected from the group consisting of apple, pear, orange, grape and mixtures thereof.

3. The frozen carbonated beverage of claim 1 wherein the fruit juice comprises juice from concentrate.

4. The frozen carbonated beverage of claim 1 wherein the fruit juice comprises fresh juice.

5. The frozen carbonated beverage of claim 1 comprising from about 2-25% by volume fruit juice.

6. The frozen carbonated beverage of claim 1 further comprising vitamins.

7. The frozen carbonated beverage of claim 1 comprising from about 40% to about 60% by volume carbon dioxide.

8. The frozen carbonated beverage of claim 1 further comprising a foaming agent.

9. The frozen carbonated beverage of claim 1 further comprising a nutritive sweetener.

10. The frozen carbonated beverage of claim 1 further comprising a non-nutritive sweetener.

11. A concentrate for making a frozen carbonated beverage comprising:
from about 6-80% by weight fruit juice;
a foaming agent; and
water.

12. The concentrate of claim 11 comprising from about 2-25% fruit juice.

13. The concentrate of claim 11 comprising from about 0.16% to about 14% by weight of a fruit juice concentrate.

14. The concentrate of claim 13 wherein the fruit juice concentrate is from about a 2:1 to about a 7:1 concentrate from fruit juice.

15. The concentrate of claim 11 further comprising at least one vitamin.

16. A method of making a frozen carbonated beverage comprising combining fruit juice, water, and carbon dioxide at reduced temperature.

17. A reduced calorie frozen carbonated beverage comprising:
from about 1-25% fruit juice by volume;
a reduced calorie or non-caloric sweetener;
a freezing point depressant;
water; and
carbon dioxide.

18. The reduced calorie frozen carbonated beverage of claim 17 comprising from about 2-10% fruit juice by volume.

19. The reduced calorie frozen carbonated beverage of claim 17 wherein said freezing point depressant is selected from the group consisting of tagatose, erythritol, isomalt, maltitol, lacitol and fructo-oligosaccharide.

20. A method of making a reduced calorie frozen carbonated beverage comprising: combining fruit juice, water, a reduced calorie or non-caloric sweetener, a freezing point depressant and carbon dioxide at reduced temperature.

21. A reduced calorie frozen carbonated beverage concentrate comprising:
from about 6% to about 50% fruit juice by volume;
water;
a reduced calorie or non-caloric sweetener; and
a freezing point depressant.

22. The reduced calorie frozen carbonated beverage concentrate of claim 21 wherein said fruit juice comprises from about 6% to about 25% by weight of the concentrate.

22. The reduced calorie frozen carbonated beverage concentrate of claim 21 wherein said fruit juice is present in concentrate form.
